(19) United States
(12) Patent Application Publication
(10) Pub. No.: US 2007/0203037 A1
(43) Pub. Date: Aug. 30, 2007

(54) Lubricant, magnetic recording medium and head slider

(75) Inventors: Hiroshi Chiba, Kawasaki (JP); Masaaki Sasa, Kawasaki (JP); Yukiko Oshikubo, Kawasaki (JP); Keiji Watanabe, Kawasaki (JP); Eishin Yamakawa, Kawasaki (JP); Takeshi Tokairin, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/495,582

(22) Filed: Jul. 31, 2006

(30) Foreign Application Priority Data
Feb. 28, 2006 (JP) 2006-051443

(51) Int. Cl. G11B 5/65; C10M 169/04

(52) U.S. Cl. 508/582; 428/835.7; 428/814; 428/815.1; 508/590

(57) ABSTRACT

A lubricant is provided that achieves a sufficiently small one-molecule-layer film thickness even when it has a high molecular weight, and has an increased reliability in a wide temperature range environment without losing the flying stability, by making the film thickness of a lubricant layer very small when it is used for the magnetic recording medium lubricant layer and/or head slider lubricant layer of a magnetic recording device. This lubricant comprises a fluorine-containing polymer, the lubricant having a relationship: Y<−1.4475X+2.815, wherein Y is a natural logarithm of diffusion coefficient at 23° C. (unit:μm²/s); and X is a viscosity at 20° C. (unit: Pas), or it comprises a fluorine-containing polymer having a particular structure, and with molecular chains between adjacent polar groups that have a number-average molecular weight of not less than 500.

### CROSS-REFERENCE TO RELATED APPLICATIONS

This application is based upon and claims the benefit of priority from the prior Japanese Patent Application No. 2006-051443, filed on Feb. 28, 2006, the entire contents of which are incorporated herein by reference.

### BACKGROUND OF THE INVENTION

1. Field of the Invention

The present invention relates to a lubricant for magnetic recording devices.

2. Description of the Related Art

In a magnetic recording device, a head slider equipped with a record transducer (also simply referred to as a head in this invention) reads and writes information while floating over a hard disk which is a magnetic recording medium.

The distance between the head and the magnetic layer for recording (writing) or reproducing (reading) the magnetic information on a hard disk is called a magnetic spacing. The recording density improves the more, the narrower the magnetic spacing is. On the other hand, it is necessary to have a higher hard disk rotational speed in order to increase the information transfer speed. With the increase in the recording density and information transfer speed in recent years, the trend towards a lower floating height and a higher rotational speed has advanced with the result that the head flying height (also called head floating height) is on the order of 10 nm, and the rotational speed is on the order of 15,000 rpm/min (rpm), at present.

Regarding a hard disk drive, a lubricant is generally applied onto the magnetic disk and head slider in a thickness of about 1 to about 2 nm in order to heighten the reliability of the drive. This lubricant reduces the friction and wear, and prevent the occurrence of disorders when the head contacts the disk.

Since the film thickness of the lubricant is about 10% of the head flying height, the thickness has turned to be a factor which cannot be ignored for the magnetic spacing (see, for example, X, Ma et al., I.E.E.E. Trans. Magn., 2001, Vol. 37, p. 1824). Accordingly, for the purpose of improving the recording density, it is becoming important to make the film thickness of the lubricant smaller so as to decrease the magnetic spacing.

However, since the molecular size of a lubricant has a certain limitation, it is not possible to make the lubricant film thickness smaller than the film thickness of one molecule layer, or one-molecule-layer film thickness. Although it may be possible to make the average value smaller than that, it will result in decreased coverage of the lubricant.

It is known that the one-molecule-layer film thickness of a lubricant is determined by the molecular weight of the lubricant (see, for example, X. Ma et al., “Journal of Chemical Physics”, 1999, Vol. 110, p. 3,129-3,137). Accordingly, it is possible to make the one-molecule-layer film thickness smaller by making the molecular weight lower.

However, if a lubricant has a lower molecular weight, it is more liable to evaporate. In addition, it tends to be dissipated more easily at a higher rotation speed. Thus, at present, the drive towards a smaller molecule also has its own limitation in consideration of the HDI (head disk interface) properties such as loss of the lubricant at the time of high-speed rotation. Therefore, it is necessary to have a lubricant that provides a sufficiently small one-molecule-layer film thickness even when it has a high molecular weight, in order to go beyond this limitation.

In addition, while a hard disk drive is used in a wide temperature range environment from a low temperature to a high temperature, a lubricant with a higher viscosity generally produces a better durability at a high temperature. Increase of the viscosity may be achieved by having a higher molecular weight, or by using a lubricant having a terminal group with higher polarity. However, if the molecular weight is made higher, the one-molecule-layer film thickness will be larger, making it less appropriate for achieving a lower flying height. Furthermore, if the viscosity is made higher, the loss of the lubricant due to friction, etc. will be more pronounced at a low temperature, deteriorating the durability of the magnetic recording medium and the head.

It is an object of the present invention to solve such problems, and develop a technology to make the film thickness of a lubricant layer very small even when the lubricant for use has a high molecular weight, and to increase the reliability in a wide temperature range environment without losing the flying stability. The other objects and advantages of the present invention will be clarified in the following explanations.

### SUMMARY OF THE INVENTION

According to one aspect of the present invention, a lubricant is provided that comprises a fluorine-containing polymer, and has a relationship: Y<−1.4475X+2.815, wherein Y is a natural logarithm of diffusion coefficient at 23° C. (unit:μm²/s); and X is a viscosity at 20° C. (unit: Pas).

According to another aspect of the present invention, a lubricant is provided that comprises a fluorine-containing polymer having a structure represented by formula 1, and with molecular chains between adjacent polar groups that have a number-average molecular weight of not less than 500.

H—{(XZ)ₘ, (YZ)ₙ}—(X_{δ}, Y_{(1-δ)})—H (1)

[in formula 1, m and n are each a real number not less than zero (where m and n are not zero at the same time); {(XZ)ₘ, (YZ)ₙ} indicates that the structural unit XZ and the structural unit YZ may be mutually in a random sequence or blocked sequence; similarly, (X_{δ}, Y_{(1-δ)}) indicates that the structural unit X and the structural unit Y may be mutually in a random sequence or blocked sequence; δ is a real number not less than zero and not more than 1; the chemical structures of X, Y and Z are as shown in formulae 12, 13 and 14 in this order (where each hydrogen of X, Y and Z may be replaced with an organic group having 1-3 carbons that may comprise an ether bond, and also comprise either one or both of a polar group and fluorine as substituents for hydrogen thereof),

—O(CH₂CH₂O)ₐCH₂CF₂O(CF₂CF₂O)ₚ(CF₂O)_{q}CF₂CH₂(OCH₂CH₂)_{b}O— (12)

{in formula 12, a, b, p and q are each a real number not less than zero (where p and q are not zero at the same time); and the structure units of CF₂CF₂O and CF₂O may be mutually in a random sequence or blocked sequence},

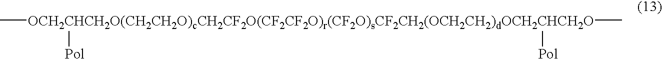

{in formula 13, c, d, r and s are each a real number not less than zero (where r and s are not zero at the same time); the structure units of CF₂CF₂O and CF₂O may be mutually in a random sequence or blocked sequence; and Pols are, independently from each other in the formula and from the other formulae, a polar group},

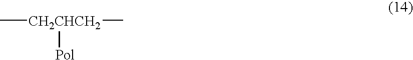

(in formula 14, Pol is, independently from the other formulae, a polar group).

By employing the above-described aspects, a lubricant is provided that gives a lubricant layer with a sufficiently small one-molecule-layer film thickness even when the lubricant has a high molecular weight. When this lubricant is used, it is possible to make the film thickness of a lubricant layer very small even when the lubricant has a high molecular weight, and to increase the reliability in a wide temperature range environment without losing the flying stability. The above-described aspects can be employed in combination.

Regarding the above-described aspects and combination thereof, preferable are that the average molecular weight of the fluorine-containing polymer is not less than 2,000 and not more than 12,000; that the Pol is a hydroxy group; that the number-average molecular weight of molecular chains between adjacent polar groups of the fluorine-containing polymer is not more than 3,000; that the fluorine-containing polymer has a terminal group with a structure represented by formula 3,

—R (3)

(in formula 3, R is a polar group or hydrocarbon group); that part or the whole of the structure units of CF₂O and C₂F₄O of formula 1 is replaced with either one of structures represented by formulae 4 and 5;

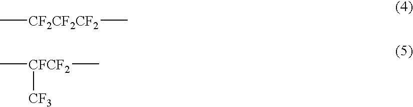

that the fluorine-containing polymer has no polar group except for a hydroxy group; and that the fluorine-containing polymer has from 1.0 to 10.0 hydroxy groups on an average in a molecule at intermediate sections of the molecular chains.

According to still another aspect of the present invention, a lubricant is provided that comprises a fluorine-containing polymer formed by reacting a compound having a structure represented by formula 2 and epichlorohydrin, having a number-average molecular weight of not less than 2,000 and not more than 12,000, and having from 1.0 to 10.0 hydroxy groups on an average in a molecule at intermediate sections of the molecular chains.

HO(CH₂CH₂O)ₓCH₂CF₂O(CF₂CF₂O)_{p″}(CF₂O)_{q″}CF₂CH₂(OCH₂CH₂)_{y}OH (2)

{in formula 2, p″, q″, x, and y are, independently from each other, a real number not less than zero (where p″ and q″ are not zero at the same time); and the structure units of CF₂CF₂O and CF₂O may be mutually in a random sequence or blocked sequence}.

By this aspect, a lubricant is provided that gives a sufficiently small one-molecule-layer film thickness even when the lubricant has a high molecular weight. When this lubricant is used, it is possible to have a lubricant layer that gives a very small film thickness when the lubricant has a high molecular weight, and it is possible to increase the reliability in a wide temperature range environment without losing the flying stability.

Preferable are that the lubricant comprises a fluorine-containing polymer formed by reacting a compound having a structure represented by formula 2 and epichlorohydrin followed by reaction with glycidol; that the fluorine-containing polymer has a terminal group with a structure represented by formula 3,

—R (3)

(in formula 3, R is a polar group or a hydrocarbon group); that part or the whole of the structure units of CF₂O and C₂F₄O of formula 2 is replaced with either one of structures represented by formulae 4 and 5;

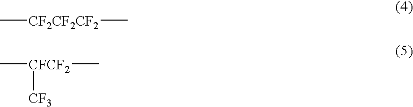

that the lubricant comprises a fluorine-containing compound other than the fluorine-containing polymer; and that the fluorine-containing compound other than the fluorine-containing polymer is at least one compound selected from the group consisting of compounds having structures represented by formulae 9, 10 and 11,

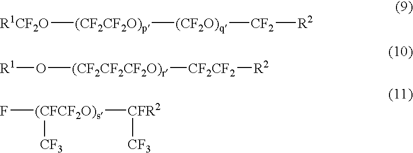

(in formulae 9-11, R¹ and R² are, independently from each other in a formula and in each formula independently from the other formulae, a group selected from the group consisting of a hydroxy group, a carboxy group, an amino group, and a phosphazene ring, a monovalent aliphatic hydrocarbon group that comprises, as a substituent group or substituent groups, one or more groups selected from the group consisting of a hydroxy group, a carboxy group, an amino group, and a phosphazene ring, may comprise a carbonyl group, an ether group, or carbonyl and ether groups, may comprise a double bond, a triple bond, or double and triple bonds, and may be branched, and a monovalent aromatic hydrocarbon group and monovalent heterocyclic aromatic hydrocarbon group that have each, as a substituent group or substituent groups, one or more groups selected from the group consisting of a hydroxy group, a carboxy group, an amino group, and a phosphazene ring; p′, q′, r′ and s′ are each a positive real number; and each structure unit in formulae 9-11 may be mutually in a random sequence or blocked sequence in the structure of each compound).

According to still other aspects of the present invention, provided are a magnetic recording medium comprising a magnetic layer, a protective layer over the magnetic layer, and a magnetic recording medium lubricant layer on the protective layer, wherein the magnetic recording medium lubricant layer is formed by application of the above-described lubricant; and a head slider equipped with a record transducer for recording information to and/or reproducing information from a magnetic recording medium, the head slider having, on the surface facing the magnetic recording medium, a protective layer and a head slider lubricant layer formed by application of the above-described lubricant.

According to the above-described various aspects, provided are a magnetic recording medium, head slider and magnetic recording device that give a lubricant layer with a very small film thickness, furnishing an increased reliability in a wide temperature range environment without losing the flying stability.

The present invention provides a lubricant that gives a one-molecule-layer film thickness which is sufficiently small, even when it is highly polymerized. When this lubricant is used for a magnetic recording medium lubricant layer and a head slider lubricant layer for a magnetic recording device, it can decrease the film thickness of the lubricant layers very small, and can increase the reliability in a wide temperature range environment without losing the flying stability.

### BRIEF DESCRIPTION OF THE DRAWINGS

FIG. 1 is a schematic view showing the state of a fluorine-containing polymer attached to a surface to be coated with the polar groups, Pols;

FIG. 2 is another schematic view showing the state of a fluorine-containing polymer attached to a surface to be coated with the polar groups, Pols;

FIG. 3 is another schematic view showing the state of a fluorine-containing polymer attached to a surface to be coated with the polar groups, Pols;

FIG. 4 is a view illustrating how to calculate the number-average molecular weight of molecular chains between adjacent polar groups;

FIG. 5 is an FT-IR chart of a compound provided in EXAMPLE 1;

FIG. 6 is a ¹HNMR chart of a compound provided in EXAMPLE 1;

FIG. 7 is a ¹³CNMR chart of a compound provided in EXAMPLE 1;

FIG. 8 is a ¹⁹FNMR chart of a compound provided in EXAMPLE 1;

FIG. 9 is a chart obtained by an ellipsometer showing the cross-sectional profile of a lubricant film thickness;

FIG. 10 is a graph showing the relationship between the number-average molecular weight (Mc) of the structural parts between adjacent hydroxy groups and the one-molecule-layer film thickness;

FIG. 11 is a chart showing the result of a glide test;

FIG. 12 is another chart showing the result of a glide test;

FIG. 13 is a chart showing the test results of TDV and TOV;

FIG. 14 is another chart showing the test results of TDV and TOV;

FIG. 15 is a graph showing the temperature-dependent viscosity properties of lubricants;

FIG. 16 shows charts of film thickness profiles just immediately after the application;

FIG. 17 shows charts of the film thickness profiles 140 hours after the application;

FIG. 18 shows a chart of a film thickness profile just immediately after the application;

FIG. 19 shows a chart of the film thickness profile 140 hours after the application;

FIG. 20 is a graph showing the relationship between the viscosity at 20° C. and a natural logarithm of the diffusion coefficient at 23° C.;

FIG. 21 is a schematic plan view of a hard disk device showing the inner structures; and

FIG. 22 is a schematic cross-sectional view of a hard disk device showing the relationship between the head and the magnetic recording medium.

### DESCRIPTION OF THE PREFERRED EMBODIMENTS

Embodiments of the present invention are explained below using figures, tables, formulae, examples and the like. These figures, tables, formulae, examples and the like as well as the explanations exemplify the present invention, and do not limit its scope. Other embodiments can of course fall within the scope of the present invention to the extent that they match the intent of the present invention.

Perfluoropolyethers having polar groups at intermediate sections of molecules are known for lubricants that provide a molecular structure with which a higher molecular weight does not result in a larger one-molecule-layer film thickness {(see, for example, Japanese Unexamined Patent Application Publication No. 2003-162810 (claims)}. However, specific molecular structures, molecular weight ranges, etc. thereof have been left unknown.

As a result of studies, it was found that a fluorine-containing polymer having a specific structure other than those having a perfluoro structure can make a lubricant layer with a very small film thickness even if it has a high molecular weight, and can raise the reliability in a wide temperature environment without losing the flying stability, when used for the magnetic recording medium lubricant layer and the head slider lubricant layer of a magnetic recording device.

That is, a lubricant according to the present invention comprises a fluorine-containing polymer formed by reacting a compound having a structure represented by formula 2 and epichlorohydrin, having a number-average molecular weight of not less than 2,000 and not more than 12,000, and having from 1.0 to 10.0 hydroxy groups on an average in a molecule at intermediate sections of the molecular chains.

HO(CH₂CH₂O)ₓCH₂CF₂O (CF₂CF₂O)_{p″}(CF₂O)_{q″}CF₂CH₂(OCH₂CH₂)_{y}OH (2)

{in formula 2, p″, q″, x, and y are, independently from each other, a real number not less than zero (where p″ and q″ are not zero at the same time); and the structure units of CF₂CF₂O and CF₂O may be mutually in a random sequence or blocked sequence}.

In the present invention, including descriptions hereunder, when a symbol indicated by a subscript represents a “real number”, the “real number” means an average number of the part or the compound having the structure.

Any known method may be employed for the above-described reaction. This fluorine-containing polymer may also be obtained through various other reaction steps and purification steps, in addition to the above-described reaction. The hydroxy groups present at intermediate sections of molecular chains are derived from epichlorohydrin. The terminal structures of the molecules are mostly hydroxy groups.

Furthermore, the lubricant according to the present invention may comprise a fluorine-containing polymer formed by reacting a compound having a structure represented by formula 2 and epichlorohydrin followed by reaction with glycidol, having a number-average molecular weight of not less than 2,000 and not more than 12,000, and having from 1.0 to 10.0 hydroxy groups on an average in a molecule at intermediate sections of the molecular chains. The lubricant may also be obtained through various other reaction steps and purification steps, in addition to the above-described reactions.

Any known method may be employed for the above-described reaction. The hydroxy groups at intermediate sections of the molecular chains are derived from epichlorohydrin. The —CH₂—CH(OH)—CH₂—OH at the ends of molecular chains is derived from glycidol.

The terminal hydroxy groups may be substituted or capped with other groups, by reacting the resultant polymer with an appropriate compound. Methyl iodide, carboxylic anhydride, etc. may be used for the substitution or capping. By this, the terminal groups of the fluorine-containing polymer acquires a structure represented by formula 3. OCOCH₃, COOH, OCH₃ and OCH₂CH₃ are examples of a polar R group, and alkyl groups are examples of a hydrocarbon R group.

—R (3)

(in formula 3, R represents a polar group or hydrocarbon group.)

Furthermore, it is also preferable that a fluorine-containing polymer according to the present invention is obtained by using a compound represented by formula 2 wherein part or the whole of the structure units of CF₂O and C₂F₄O of formula 2 is replaced with either one of structures represented by formulae 4 and 5.

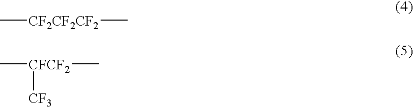

It is to be noted that a structure similar to that represented by formula 1 can be synthesized by reacting epichlorohydrin and/or glycidol with a commercially-available fluorine-containing polymer comprising the structure(s) represented by formula 4 and/or formula 5.

By the present invention, provided is a lubricant that gives a one-molecule-layer film thickness sufficiently small even when the lubricant has a high molecular weight. It is thought that in a lubricant comprising a fluorine-containing polymer having such a structure, probably, the polar groups (hydroxy groups) present at intermediate sections of molecules are adhered to a surface to which the lubricant is applied (called a surface to be coated, hereafter), together with the polar groups (hydroxy groups) at both molecular ends and in the vicinity thereof, and accordingly, the molecule does not rise high above the coated surface, and this effect makes it possible for a lubricant layer to have a very small film thickness, even when the lubricant has a high molecular weight.

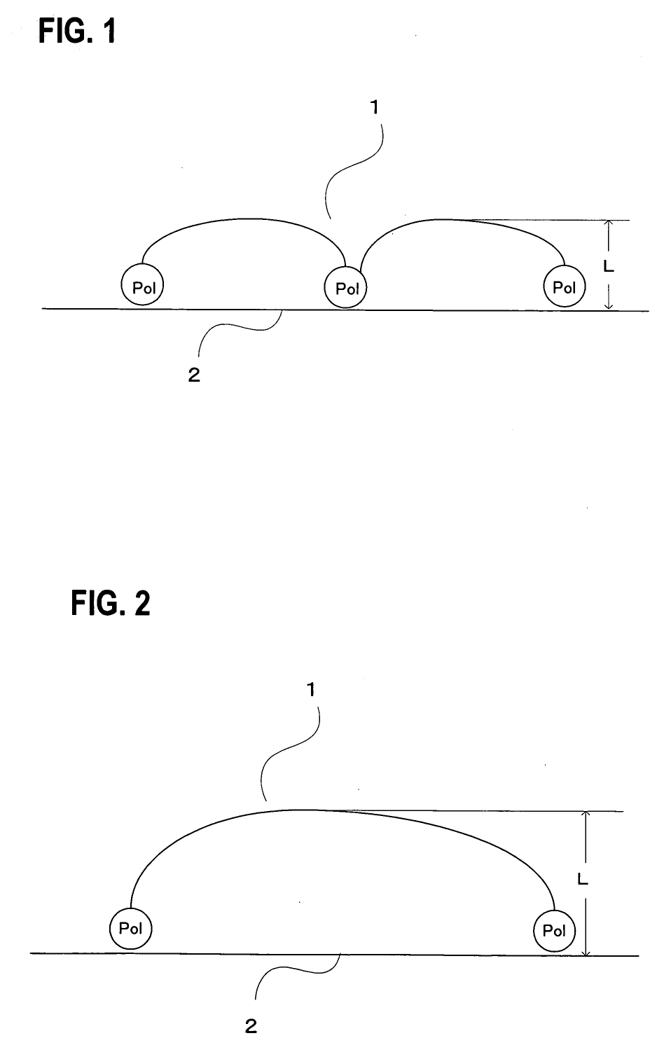

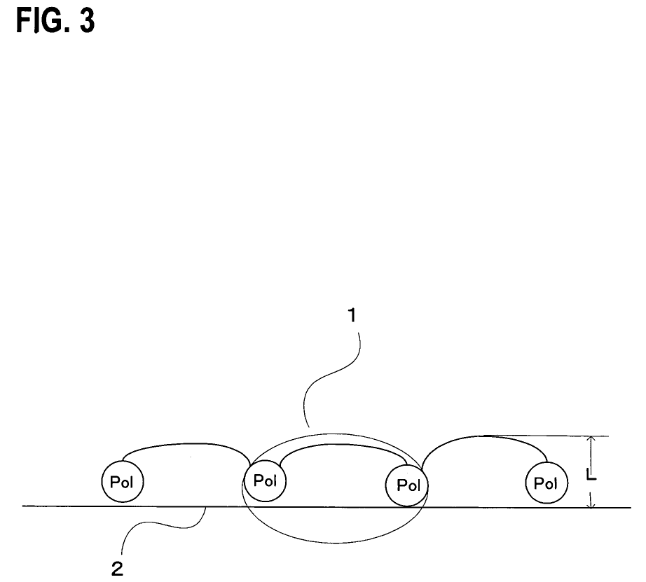

FIGS. 1-3 explain how the states are. FIG. 2 is a schematic view showing a state wherein there are polar groups Pols at both ends of a fluorine-containing polymer 1; FIG. 1, a state wherein there is one polar group Pol at an intermediate section of a molecular chain as well as two at both ends of a fluorine-containing polymer 1; and FIG. 3, a state wherein there are two polar groups Pols at intermediate sections of a molecular chain as well as two at both ends of a fluorine-containing polymer 1. Supposing that FIGS. 1-3 have the same molecular length, it can be understood that the distance L with which the molecule 1 of a fluorine-containing polymer is away from the coated surface 2 is smaller, when there is (or are) polar group(s) at an intermediate section(s) of the molecular chain.

Therefore, as a result of the investigations, it is possible to consider that a lubricant comprising a fluorine-containing polymer having a structure represented by formula 1, having a number-average molecular weight of not less than 2,000 and not more than 12,000, and having from 1.0 to 10.0 hydroxy groups on an average in a molecule at intermediate sections of the molecular chains, can provide a similar effect to the above-described lubricant, even if it is formed from any raw materials, not to mention the above-described compositions of raw materials.

In any of the above cases, the number of hydroxy groups at intermediate sections of molecular chains is preferably 1.0-5.0 on an average in a molecule. Less than 1.0, the one-molecule-layer film thickness tends to become larger. In a typical case, the one-molecule-layer film thickness may exceed 2 nm. Over 10.0, no particular improvement is achieved. Rather, when the number-average molecular weight of a fluorine-containing polymer is in the range of 2,000-12,000 as will be described later, it will typically result in a state in which too many hydroxy groups are present in a too-short molecular chain, and the molecules are liable to cohere due to the intermolecular interaction by the hydroxy groups, causing the lubricant film thickness fluctuate (that is, the lubricant film thickness will increase locally as time passes).

In the above-described range, as long as the adherence to the surface to be coated has gone well, it can be considered that the distance L with which the fluorine-containing polymer according to the present invention is away from the coated surface will be on the same order as the distance L with which a fluorine-containing polymer is away from the coated surface, the latter polymer having polar groups only at the ends, and having, as a whole molecule, a molecular weight of the same value as that of the structural parts between the polar groups of the former polymer.

Regarding the number-average molecular weight, less than 2,000, the migration properties indicated by the durability at a high temperature and the rate of decrease in film thickness, will be deteriorated. Also, the lubricant tends to be more easily dissipated at a high rotation. Over 12,000, the viscosity would be too high, and the above-described durabilities of a magnetic recording medium and head at a low temperature tend to be degraded.

If the above description is further generalized, it can be investigated from the viewpoint of how is the level of the chemical formula weight of at least one molecular chain among the molecular chains between polar groups, when there are one or more polar groups present at intermediate sections of the molecular chain.

As a result of investigations based on this consideration, it was found that a lubricant can be obtained that can make the one-molecule-layer film thickness sufficiently small, if the requirements are satisfied that polar groups other than a hydroxy group can be appropriately selected from known polar groups including, for example, a carboxy group, carbonyl group, sulfonic acid group, nitro group, and nitrile group (not including an ether bond, though), that the fluorine-containing polymer included in a lubricant has a structure represented by formula 1,

H—{(XZ)ₘ, (YZ)ₙ}—(X_{δ}, Y_{(1-δ)})—H (1)

[(in formula 1, m and n are each a real number not less than zero (where m and n are not zero at the same time); {(XZ)ₘ, (YZ)ₙ} indicates that the structural unit XZ and the structural unit YZ may be mutually in a random sequence or blocked sequence; similarly, (X_{δ}, Y_{(1-δ)}) indicates that the structural unit X and the structural unit Y may be mutually in a random sequence or blocked sequence; δ is a real number not less than zero and not more than 1; the chemical structures of X, Y and Z are as shown in formulae 12, 13 and 14 in this order (where each hydrogen of X, Y and Z may be replaced with an organic group having 1-3 carbons that may comprise an ether bond, and also comprise either one or both of a polar group and fluorine as substituents for hydrogen thereof),

—O(CH₂CH₂O)ₐCH₂CF₂O(CF₂CF₂O)ₚ(CF₂O)_{q}CF₂CH₂(OCH₂CH₂)_{b}O— (12)

{in formula 12, a, b, p and q are each a real number not less than zero (where p and q are not zero at the same time); and the structure units of CF₂CF₂O and CF₂O may be mutually in a random sequence or blocked sequence},

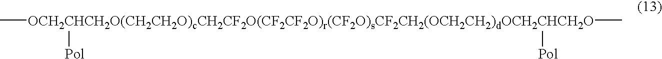

{in formula 13, c, d, r and s are each a real number not less than zero (where r and s are not zero at the same time); the structure units of CF₂CF₂O and CF₂O may be mutually in a random sequence or blocked sequence; and Pols are, independently from each other in the formula and from the other formulae, a polar group},

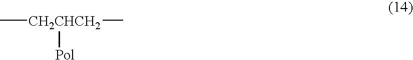

(in formula 14, Pol is, independently from the other formulae, a polar group)]; and that the number-average molecular weight of molecular chains between adjacent polar groups is not less than 500. Regarding the molecular weight of the fluorine-containing polymer according to the present invention, a number-average molecular weight of not less than 2,000 and not more than 12,000 is preferable. Reasons similar to the above description may be applied to the upper and lower limits of the average molecular weight in general, and particularly for a magnetic recording media.

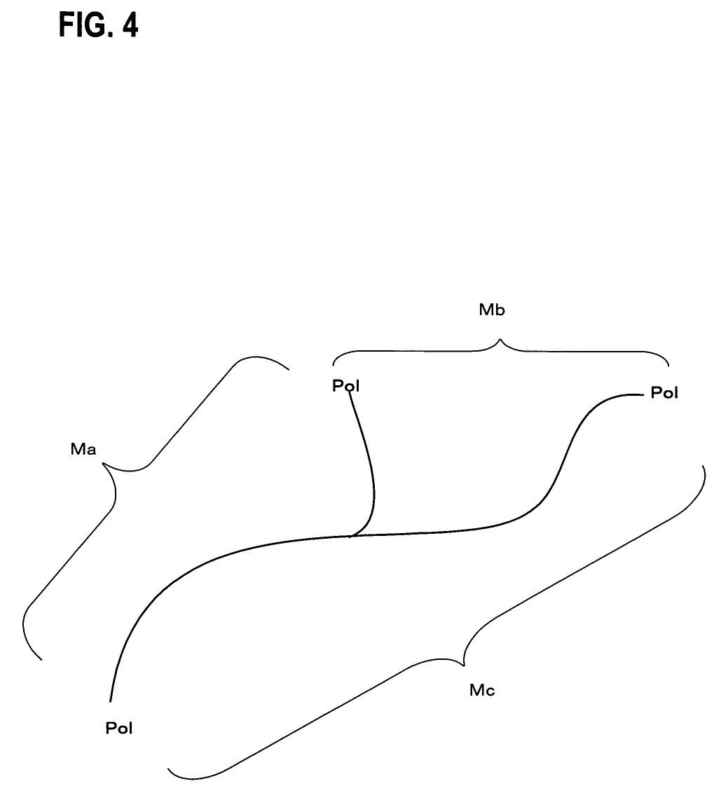

The polar groups themselves are not included in the calculation of the number-average molecular weight of molecular chains between adjacent polar groups. When no branched structure is present between adjacent polar groups, the number-average molecular weight can be determined of the molecular chains between the adjacent polar groups on the polymer chain. If a branched structure(s) without polar groups is present between adjacent polar groups, the molecular weight is counted without counting the branched structure(s). If a branched structure(s) with a polar group(s) is present between adjacent polar groups, the molecular weight between adjacent polar groups when seen from the polar group(s) on the branched structure(s) is also counted. In that case, the molecular weight is counted without counting the structural parts branching out from the chain part connecting the adjacent polar groups. In the case of FIG. 4, for example, Ma, Mb and Mc are counted. In FIG. 4, Pol represents a polar group. Here, the term “adjacent” in the present invention refers to the relationship of a polar group with a next polar group on a polymer chain (including a branched chain), as shown in FIG. 4.

There are cases in which polar groups at the molecular ends and in the vicinity thereof are close to each other. If the molecular chains between adjacent polar groups which are present at the molecular ends and in the vicinity thereof are also counted into the number-average molecular weight in such a case, the fluctuation of molecular weights of molecular chains between adjacent polar groups will be larger, possibly making the above-described requirement of not less than 500 insufficient. As a result of investigations, it was found that if there are two or more polar groups (including the polar terminal groups) within five carbons from the molecular terminal, it is preferable to put them in a group to handle the part which spans five carbons from the molecular terminal as one polar group, in order to select a fluorine-containing polymer that satisfies the above-described “not less than 500” requirement.

When the thus resulted number-average molecular weight is less than 500, it is difficult to make the film thickness of the lubricant layer very small, probably because cohesion of the polymer tends to occur due to the close distance between polar groups. It is more preferable that the number-average molecular weight be not less than 1,000.

The fluorine-containing polymer having a structure represented by formula 1 may be composed of one kind, or of plural kinds. For example, when n=0 and δ=1 in formula 1, it has a structure without any Y component, and when m=δ=0, it has a structure without any X component. A fluorine-containing polymer according to the present invention may be composed of a fluorine-containing polymer having either one of the structures, or it may be composed of both of them in a mixture.

The term “each hydrogen of X, Y and Z may be replaced with an organic group having 1-3 carbons that may comprise an ether bond, and also comprise either one or both of a polar group and fluorine as substituents for hydrogen thereof” means that the structure represented by formula 1 may not only be “a structure without any branching” indicated by formula 1 itself, but also a structure with branching, that the branching in that case may comprise 1-3 carbons, and oxygen intervening between carbons, and that hydrogen bound to a carbon in that case may be substituted with a polar group and/or fluorine. The above Pol represents a polar group, independently from each other in formula 13, and between formulae 13 and 14. In the present invention, the term “polar group” refers to a polar group except an ether bond as described above. Examples of the polar group include a hydroxy group, carboxy group, carbonyl group, sulfonic acid group, nitro group and nitrile group. Generally speaking, a hydroxy group is preferable for the polar group from the viewpoint of easy acquisition, influence on the system such as corrosion, etc. In this sense, it is more preferable that the polar groups are only hydroxy groups. Also, from the viewpoint of easy production, in many embodiments, it is preferable that the fluorine-containing polymer does not comprise polar groups other than the Pol in formulae 13 and 14, and that no branched structures are included.

As will be explained in the examples, it is preferable in any of the above-described cases, that the number-average molecular weight of the molecular chains between adjacent polar groups of a fluorine-containing polymer is not more than 3,000. It was found that if the molecular weight of structural parts between adjacent polar groups, when seen from the viewpoint of average value, exceeds 3,000, the film thickness of the lubricant layer tends to be larger, and accordingly the value is preferably not more than 3,000.

Also, regarding the fluorine-containing polymer having such a structure, the terminal group may have a structure represented by formula 3 in the same way as above. The structure of R in formula 3 may be introduced by any known method.

Furthermore, in formula 1, it is also preferable that part or the whole of the structure units of CF₂O and C₂F₄O is replaced with either one of structures represented by formulae 4 and 5. With such structures, decrease of surface energy or the like will be expected.

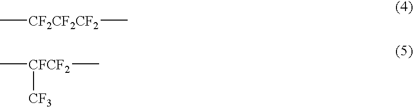

The structures represented by formulae 3, 4 and 5 may be introduced by any known method.

In the above-described fluorine-containing polymer, the condition of having from 1.0 to 10.0 polar groups (hydroxy groups, for example) on an average in a molecule at intermediate sections of the molecular chains may be employed in addition to or instead of the above-described condition of a number-average molecular weight of not less than 500. A lubricant according to the present invention may be composed only of any of the above-described fluorine-containing polymers, or may also comprise other compounds. As the other compounds, fluorine-containing compounds other than the above-described fluorine-containing polymers are preferable. These fluorine-containing compounds preferably have properties required for a lubricant regarding the molecular weight, fluorine content, etc. As such a fluorine-containing compound, at least one compound selected from the group consisting of those represented by formulae 9, 10 and 11 is preferable. They are commercially available.

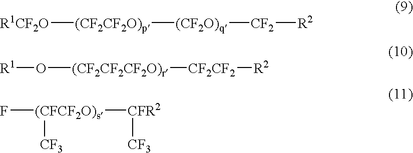

In formulae 9-11, R¹ and R² are, independently from each other in a formula and in each formula independently from the other formulae, a group selected from the group consisting of a hydroxy group, a carboxy group, an amino group, and a phosphazene ring, a monovalent aliphatic hydrocarbon group that comprises, as a substituent group or substituent groups, one or more groups selected from the group consisting of a hydroxy group, a carboxy group, an amino group, and a phosphazene ring, may comprise a carbonyl group, an ether group, or carbonyl and ether groups, may comprise a double bond, a triple bond, or double and triple bonds, and may be branched, and a monovalent aromatic hydrocarbon group and a monovalent heterocyclic aromatic hydrocarbon group that have each, as a substituent group or substituent groups, one or more groups selected from the group consisting of a hydroxy group, a carboxy group, an amino group, and a phosphazene ring; p′, q′, r′ and s′ are each a positive real number; and each structure unit in formulae 9-11 may be mutually in a random sequence or blocked sequence in the structure of each compound.

As a result of further investigations, it was found that the above-described conditions aside, even when a lubricant with a polar group is employed to increase the properties to hold the lubricant on the substrate, the presence of a particular relationship between the diffusion coefficient of the lubricant and the viscosity thereof can restrict the fluctuation in the lubricant film thickness. It is supposed that while it is considered that this fluctuation of the lubricant film thickness is caused by the cohesion of molecules due to intermolecular interaction by polar groups, the molecular cohesion can be restricted to an acceptable extent by the particular relationship between the diffusion coefficient of the lubricant and the viscosity thereof.

Specifically, it is preferable that the lubricant comprising a fluorine-containing polymer has a relationship: Y<−1.4475X+2.815, wherein Y is a natural logarithm of diffusion coefficient at 23° C.; and X is a viscosity at 20° C. It is more preferable that it has a relationship: Y<− 4/3·X+2.

Here, the diffusion coefficient is determined by a half dip method. The unit is μm²/s. A half dip method is a method in which at the time of application of a lubricant by immersion, the lubricant is applied onto a part of a disk, instead of the whole surface. In this way of application, the lubricant moves, that is diffused, to the disk surface which has not been coated, as time passes. The slope obtained from the plotting of the square of the distance of diffusion against the elapsed time is defined as the diffusion coefficient. The viscosity can be determined with a rotational viscometer or the like, for example. Pas is used as the unit.

The above-described relationship defines the relationship between the mobility (diffusion coefficient) on a substrate such as a magnetic recording medium, head slider or the like, and a intermolecular interaction (viscosity), and indicates that a lubricant that has a small intermolecular interaction and that is hard to move on a substrate shows a tendency of not cohering. The relationship defines the parameters specifically.

Such a condition can be generally applied to lubricants comprising a fluorine-containing polymer. However, it is more useful if it is applied to the various fluorine-containing polymers that have been described specifically in the above, because it is possible to select a favorable lubricant composition in a shorter time.

The above-described various lubricants according to the present invention, can be favorably used for the lubricant layers installed on the magnetic recording medium and/or head slider of a magnetic recording device. That is, a magnetic recording medium comprising a magnetic layer, a protective layer over the magnetic layer, and a magnetic recording medium lubricant layer on the protective layer wherein the magnetic recording medium lubricant layer is formed by applying the above-described lubricant, and a head slider for recording and/or record-reproducing to/from a magnetic recording medium that has a protective layer and a head slider lubricant layer which is formed by applying the above-described lubricant, on the side facing the magnetic recording medium, can make the film thickness of the lubricant layers very small, and accordingly, can comply with the request of narrow head flying height.

In this case, it is preferable to carry out heat treatment after the application of lubricant, on both magnetic recording medium lubricant layer and head slider lubricant layer, in order to improve the surface uniformity of the lubricant applied to the surface and its adhesion to the surface. The heat treatment is preferably carried out at an ambient temperature in the range of 70-150° C. for a period in the range of 0.5-2 hours. It is also preferable to carry out UV irradiation treatment after the lubricant application. Either one or both of the heat treatment and UV irradiation treatment may be performed. It is preferable to employ both of them, and perform heat treatment followed by UV irradiation treatment, in order to improve the adherence to the surface to be coated.

There is no limitation to the material for forming the surfaces of the magnetic recording medium and head slider to be coated with a lubricant according to the present invention, and any material can be appropriately selected from known materials. Those having an affinity for polar groups such as a hydroxy group to some extent are generally preferable.

A magnetic recording device according to the present invention will be explained as follows, using a hard disk device for example. The “magnetic recording device” according to the present invention may include any and all the magnetic recording devices using a magnetic recording medium and a head slider, as long as they do not contradict the gist of the present invention.

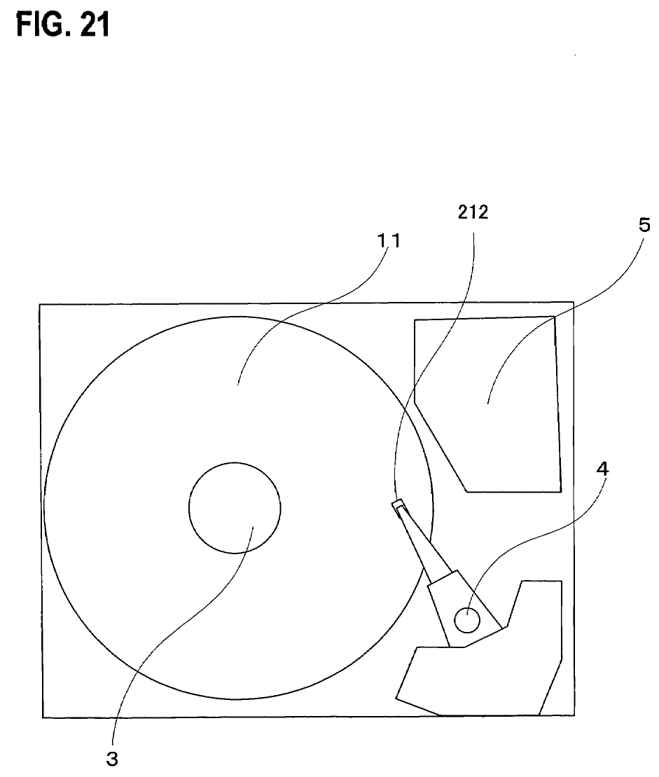

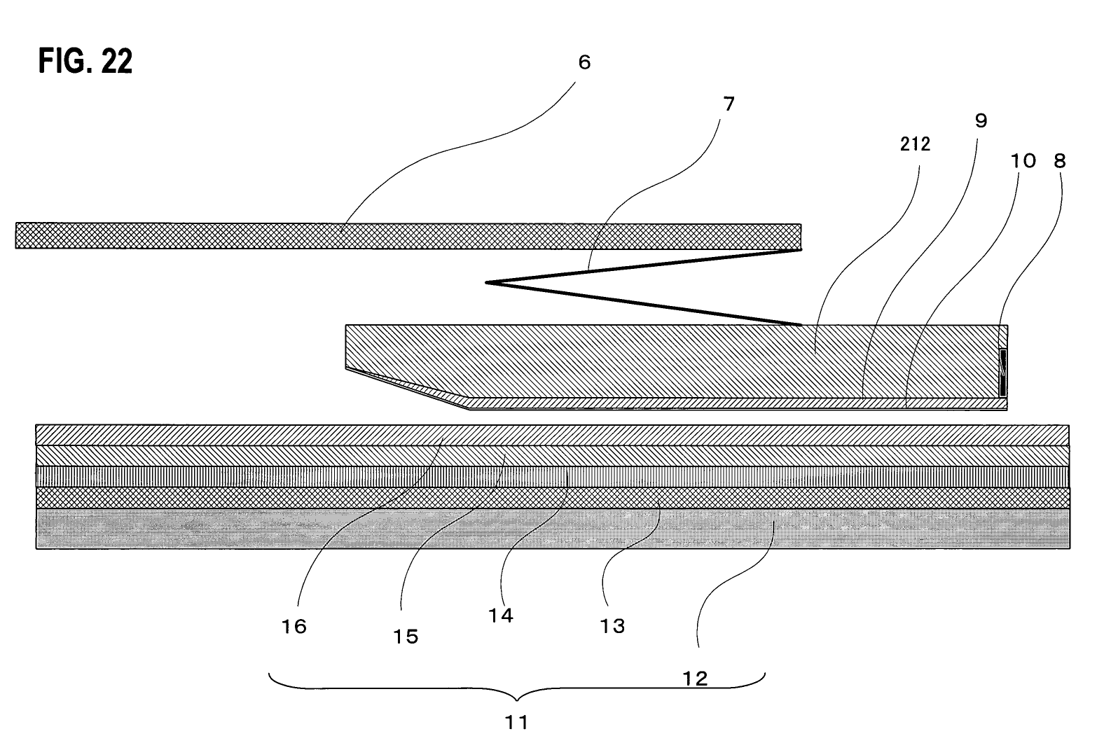

FIG. 21 is a schematic plan view of a hard disk device showing the inner structures, and FIG. 22 is a schematic cross-sectional view (a view obtained by sectioning along the direction perpendicular to the magnetic layer of the magnetic recording medium) showing the relationship between the head and the magnetic recording medium.

As shown in FIG. 21, this hard disk drive has, as main components, a magnetic recording medium 11, a head slider 212 having a head, a rotation control mechanism 3 (e.g. a spindle motor) for the magnetic recording medium 11, a head positioning mechanism 4, and recording/reproduction signal processing circuit 5 (a read/write amplifier or the like).

As shown in FIG. 22, the head slider 212 is connected to the head positioning mechanism 4 by a suspension 6 and gimbals 7 for flexibly supporting the head slider 212, and a head 8 is provided at the tip of the head slider 212. A head slider protective layer 9 and a head slider lubricant layer 10 are provided on the surface of the head slider.

The magnetic recording medium 11 has, from the bottom in FIG. 22, a substrate 12, a Cr underlayer 13, a magnetic layer 14, a magnetic recording medium protective layer 15, a magnetic recording medium lubricant layer 16 and so on. Other layers such as a seed layer may be provided, but these are omitted from the drawings.

### EXAMPLES

The following is a detailed description of examples and comparative examples of the present invention.

### Example 1

### (Synthesis of a Lubricant)

To 500 mL of acetone were added 100 g of FOMBLIN Z DOL which was commercially available (a product from Solvay Solexis, corresponding to a structure represented by formula 2 wherein x=y=0, molecular weight being 2,020) and 0.125 mole of epichlorohydrin. An aqueous solution formed by dissolving 0.11 mole of sodium hydroxide in 5 g of water was added dropwise into the mixture under good agitation for ten minutes. The mixture was heated and refluxed for 8 hours.

After that, acetone was evaporated, using an evaporator, 25 g of trifluoroacetic acid and 250 mL of water were added, and the mixture was stirred at 70° C. for 3 hours. A deposit was recovered, and was washed with water at 80° C.

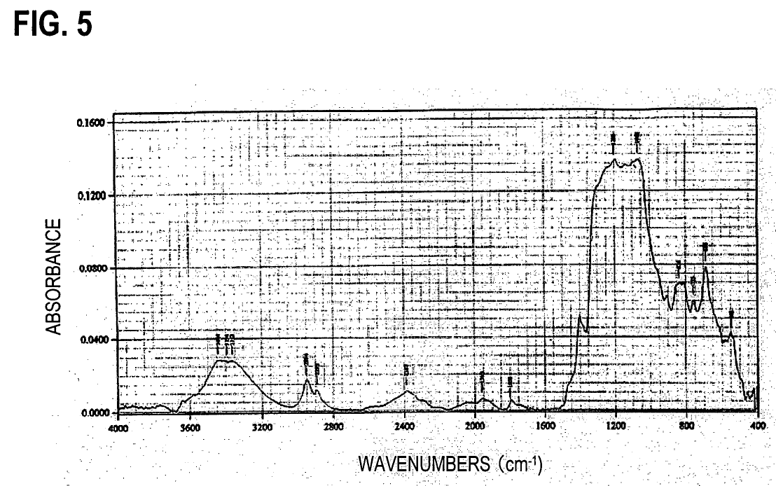

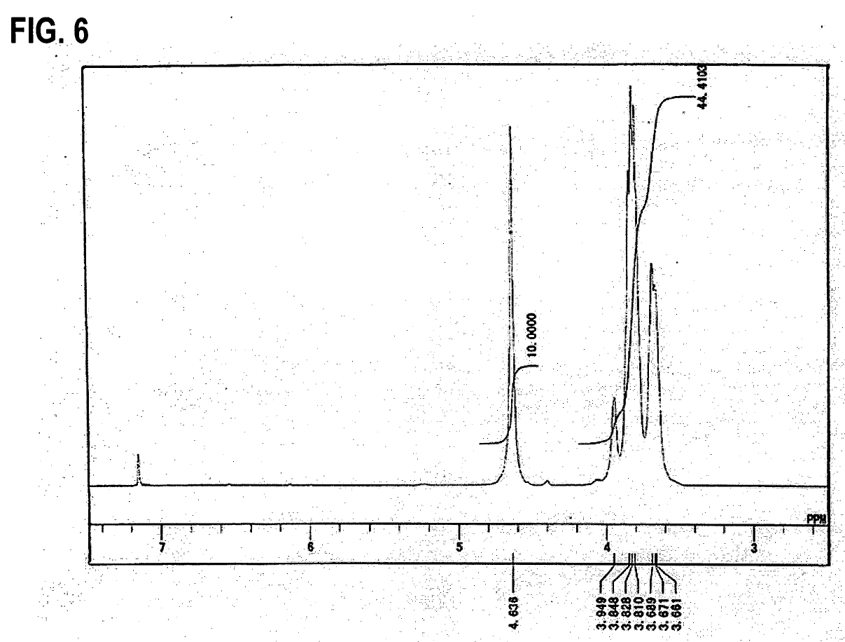

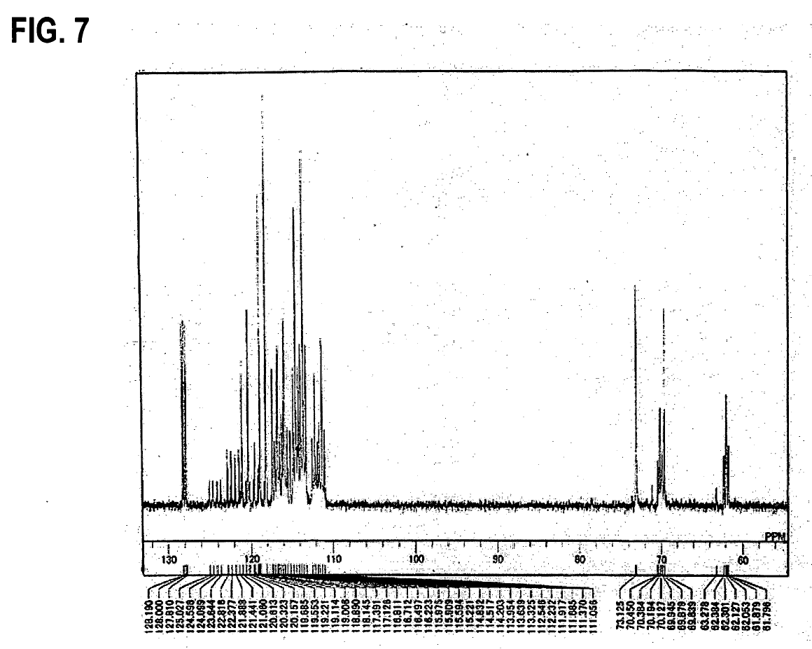

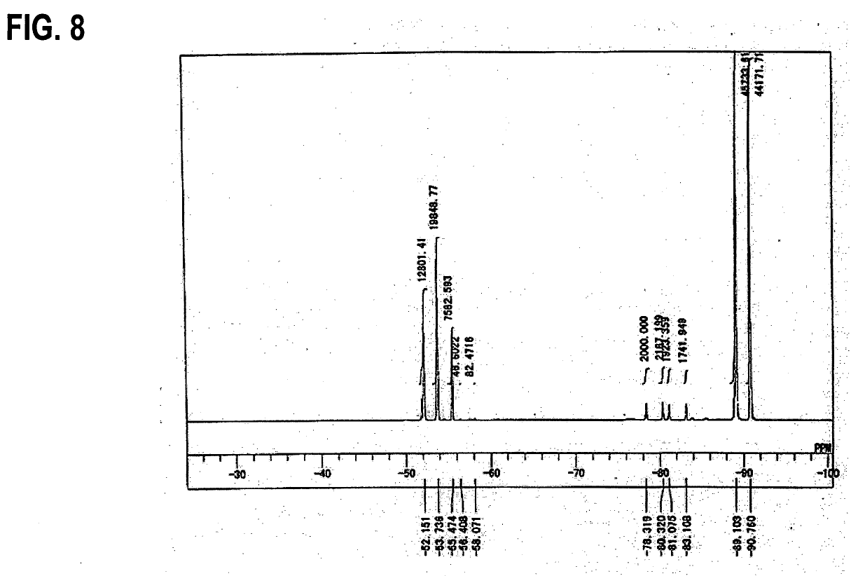

It was determined by FT-IR, ¹HNMR, ¹³CNMR, and ¹⁹FNMR that this polymer had a molecular structure represented by formula 1 wherein n=a=b=0, and δ=1. FIGS. 5-8 shows some of the resultant spectra. From the ¹⁹FNMR, it was determined that the number-average molecular weight was 4,653, the average degree of polymerization was 2.14, and the number-average molecular weight of molecular chains between adjacent hydroxy groups was 1,980. It is possible to understand that the number-average molecular weight is a mean value of the number-average molecular weights (M1, M2, . . . ) that will be described later.

In addition, the above-described polymer lubricant was subjected to dissolving and extraction, using a supercritical fluid of carbon dioxide with changing the temperature and pressure. The number-average molecular weights (Mn), average degrees of polymerization (r), number-average molecular weights (Mc) of molecular chains (M1, M2, . . . ) between adjacent polar groups (hydroxy groups), and the average numbers of hydroxy groups in one molecule of the extracted lubricants are shown in TABLE 1 together with the fraction numbers (Fr1-Fr7).

TABLE 1

| Fraction | | | | |
|---|---|---|---|---|
| No. | Mn | r | Mc | OH/molecule |
| Fr1 | 1574 | 1.13 | 1220 | 2.1 |
| Fr2 | 2211 | 1.21 | 1650 | 2.2 |
| Fr3 | 3259 | 1.47 | 2050 | 2.5 |
| Fr4 | 4774 | 2.08 | 2100 | 3.1 |
| Fr5 | 7426 | 2.94 | 2330 | 3.9 |
| Fr6 | 11328 | 4.45 | 2340 | 5.5 |
| Fr7 | 12072 | 4.55 | 2450 | 5.6 |

### Example 2

### (Measurement of a One-Molecule-Layer Film Thickness)

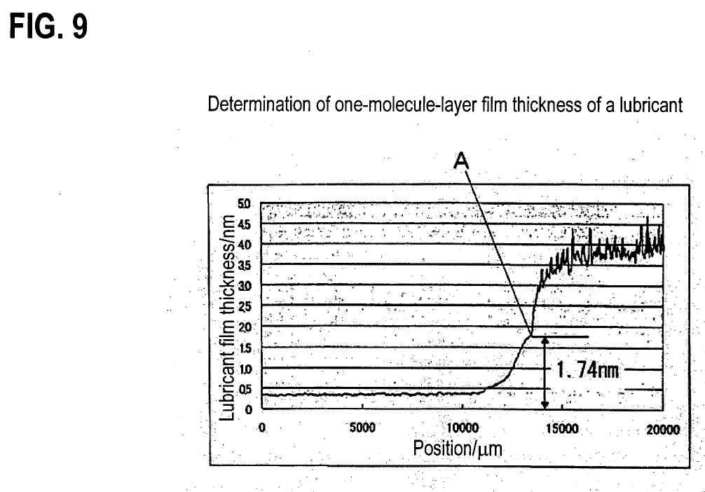

The one-molecule-layer film thickness can be obtained, as described in X. Ma et al., “Journal of Chemical Physics”, 1999, Vol. 110, p. 3,129-3,137, from the terrace structure (see A in FIG. 9) which appears when a lubricant is being fluidized (see FIG. 9), through the observation with an ellipsometer of the time-dependent change of the cross-sectional profile of a lubricant film thickness.

The lubricant Fr4 was applied to a part of a protective layer of a hard disk by means of a dip method, and the time-dependent change of the cross-sectional profile of the lubricant film thickness was observed. As a result, as shown in FIG. 9, a terrace structure appeared, and the film thickness of the terrace was determined to be 1.74 nm (that is, the one-molecule-layer film thickness). The smaller value of the part at the left of FIG. 9 indicates the protective layer surface to which no lubricant was coated. It is thought that the value of the structure at the right which is larger than that of the terrace structure indicates a film thickness structure formed by two or more molecules.

The value obtained in the same way from FOMBLIN Z DOL (molecular weight being 2,022) was 1.66 nm. In other words, it was found that the fluorine-containing polymer according to EXAMPLE 1 had approximately the same level of one-molecule-layer film thickness, even if the molecular weight was twice or more as high as FOMBLIN Z DOL. This is thought to be caused by the fact that the lubricant adheres to the substrate with the polar groups oriented towards the substrate.

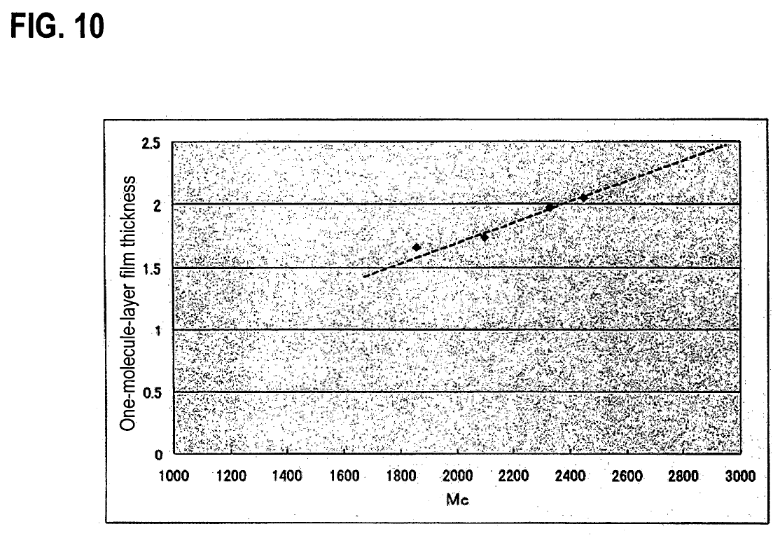

Then, the relationship between the number-average molecular weight (Mc) of molecular chains (M1, M2, . . . ) between adjacent polar groups (hydroxy groups), and the one-molecule-layer film thickness data obtained through an ellipsometer as explained above, were plotted to make FIG. 10.

As a result, it is supposed that when the number-average molecular weight is as high as 3,000, the one-molecule-layer film thickness can reach a value as large as 2.5 nm. If a general way of thinking that the coating film thickness is most probably about 80% of the one-molecule-layer film thickness, is employed here, the case of Mc being about 3,000 results in a coated film thickness of 2 nm. This value is often thought to be too large in view of its contribution to the magnetic spacing and head flying stability. Therefore, from the viewpoint of Mc, the value is more preferably not more than 3,000.

Here, it was determined from the measurement results of the surface free energy that the coverage of the coated surface was sufficient. In other words, while the surface free energy values of FOMBLIN Z DOL was 23 mN/m, it was 18 mN/m in the case of the Fr4 fluorine-containing polymer of EXAMPLE 1, which was in a sufficiently low surface energy state.

### Example 3

### (Synthesis of a Lubricant)

To 500 mL of acetone were added 100 g of FOMBLIN Z DOL TX which was commercially available (a product from Solvay Solexis, molecular weight being 2,000, the average value of x, y being 1.73, see formula 31 for the structure) and 0.125 mole of epichlorohydrin. An aqueous solution formed by dissolving 0.11 mole of sodium hydroxide in 5 g of water was added dropwise into the mixture for 10 minutes under good agitation. The mixture was heated and refluxed for 8 hours.

After that, acetone was evaporated, using an evaporator, 25 g of trifluoroacetic acid and 250 mL of water were added, and the mixture was stirred at 70° C. for 3 hours. A deposit was recovered, and was washed with water at 80° C.

H—O(CH₂CH₂O)_{1.73}CH₂CF₂O(CF₂CF₂O)ₚ(CF₂O)_{q}CF₂CH₂(OCH₂CH₂)_{1.73}O—H (31)

It was determined by FT-IR, ¹HNMR, ¹³CNMR, and ¹⁹FNMR that this polymer had a molecular structure represented by formula 32. From the ¹⁹FNMR, it was determined that the number-average molecular weight was 4,138, the average degree of polymerization was 1.98, and the number-average molecular weight of molecular chains between adjacent hydroxy groups was 1,780. It is possible to understand that the number-average molecular weight is a mean value of the number-average molecular weights (M1, M2, . . . ) that will be described later.

H—{(XZ)_{0.98}—(X)}—H (32)

In addition, the lubricant obtained by the synthesis was subjected to dissolving and extraction, using a supercritical fluid of carbon dioxide with changing the temperature and pressure. The number-average molecular weights (Mn), average degrees of polymerization (r), number-average molecular weights (Mc) of molecular chains (M1, M2, . . . ) between adjacent polar groups (hydroxy groups), and the average numbers of hydroxy groups in a molecule of the extracted lubricants are shown in TABLE 2 together with the fraction numbers (Fr1T-Fr6T).

TABLE 2

| Fraction | | | | |
|---|---|---|---|---|
| No. | Mn | r | Mc | OH/molecule |
| Fr1 T | 1345 | 1.11 | 950 | 2.1 |
| Fr2 T | 1740 | 1.3 | 1100 | 2.3 |
| Fr3 T | 2283 | 1.44 | 1370 | 2.4 |
| Fr4 T | 4013 | 1.98 | 1870 | 3.0 |
| Fr5 T | 9160 | 2.95 | 3000 | 4.0 |
| Fr6 T | 10769 | 4.34 | 2410 | 5.3 |

### Example 4

### (Evaluation of Flying Properties)

The lubricant (Fr4) obtained in EXAMPLE 1 was applied to the protective layer of a hard disk by a dip method, and a glide test was carried out for evaluating the flying properties. The coating thickness of the lubricant was 1.2 nm. The coating was subjected to heat treatment at an ambient temperature of 130° C. for 50 minutes. This test monitors the output of a piezo element while a slider on which the piezo element is mounted is being floated at the height of 6 nm with the disk rotating at the peripheral speed of 8.9 m/s.

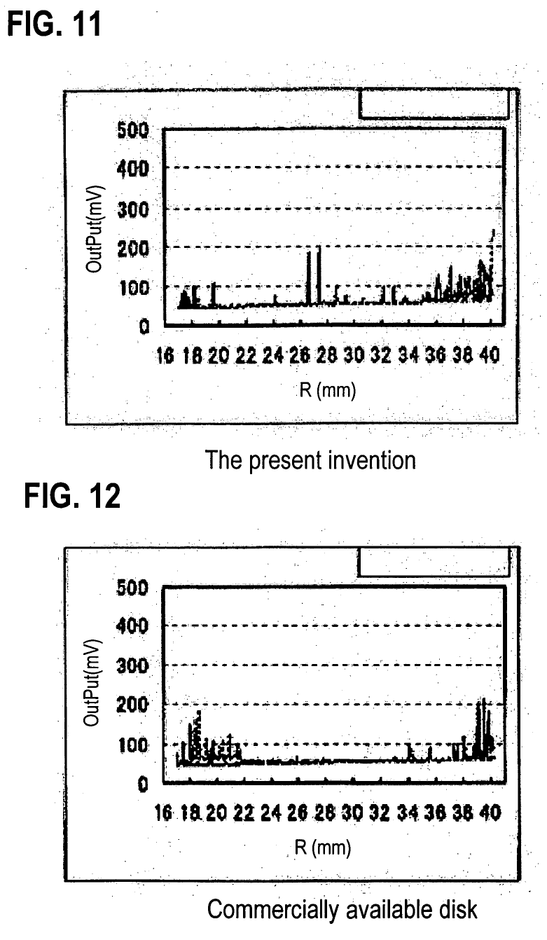

To compare, the same test was carried out for a commercially available disk having a recording density of 38 Gbit/inch² (converted value being 5.89 Gbit/cm²). As shown in FIGS. 11 and 12, there is no difference between them, indicating that the magnetic disk wherein the lubricant according to the present invention was used for the lubricant layer, showed good flying properties. In FIGS. 11 and 12, the abscissa axis represents the location on a disk in the radial direction of the disk, and the axis of ordinate represents the output voltage of the piezo element.

Furthermore, for the purpose of comparison, FOMBLIN Z DOL (molecular weight, 4,000) which was commercially available was applied to the protective layer of a hard disk by a dip method, and a glide test was carried out for evaluating the flying properties. The coating thickness of the lubricant was 1.2 nm. The coating was subjected to heat treatment at an ambient temperature of 130° C. for 50 minutes.

It was found that the head did not fly under this condition. This is thought to be caused by the fact that the molecular weight was high, and accordingly the one-molecule-layer film thickness was large, resulting in flying failure.

### Example 5

### (Evaluation of Flying Properties)

The lubricant (Fr4T) obtained in EXAMPLE 3 was applied to the protective layer of a hard disk by a dip method, in the same way as for EXAMPLE 4, and a glide test was carried out for evaluating the flying properties in the same way as for EXAMPLE 4. As a result, good flying properties were achieve with this lubricant, similarly to the Fr4 in EXAMPLE 4.

### Example 6

### (Evaluation of Flying Properties)

The take-off velocity (TOV) and touch-down velocity (TDV) were determined using a CSS (contact-start-stop) testing machine. TOV is defined as the velocity when a head starts to fly in the course of increasing the rotational speed of a disk, and TDV is defined as the velocity when a head collides with the disk in the course of decreasing the rotational speed of the disk.

The head for use was one that gave 10 nm flying height, and the lubricant (Fr4 in EXAMPLE 1) was used for the magnetic recording medium lubricant layer of the magnetic disk for use. The coating thickness was 1.2 nm. The same heat treatment was carried out as in the case of EXAMPLE 4.

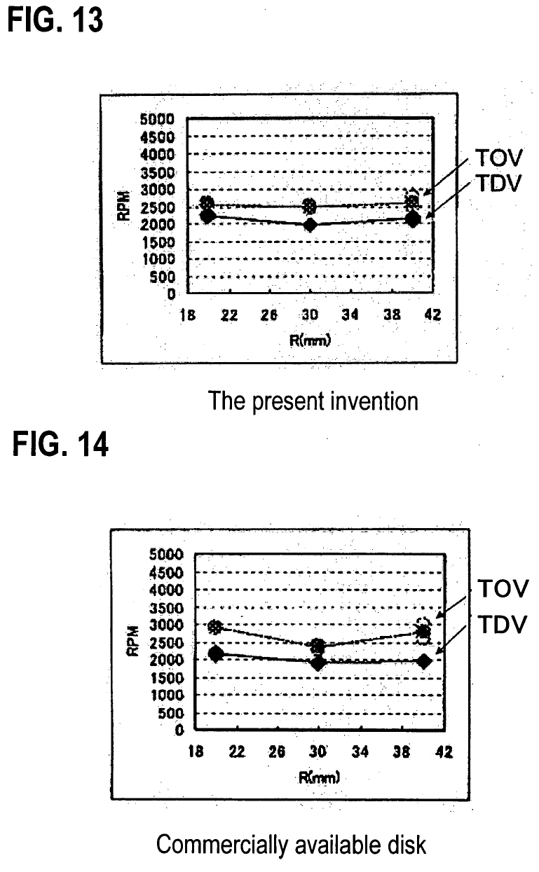

To compare, the same test was carried out for a commercially available disk having a recording density of 38 Gbit/inch² (converted value being 5.89 Gbit/cm²). The results are shown in FIGS. 13 and 14. There is no difference between them, indicating good flying properties. In FIGS. 13 and 14, the abscissa axis represents the location on a disk in the radial direction of the disk, and the axis of ordinate represents the rotational speed of the disk.

### Example 7

### (Properties at a Low Temperature)

The lubricants (Fr1-Fr7) of EXAMPLE 1 and lubricants (Fr1T-Fr6T) of EXAMPLE 3 were applied to the protective layers of hard disks by a dip method, and CSS (contact-start-stop) tests were carried out for evaluating properties at a low temperature. The coating thickness of the lubricant was 1.2 nm, and they were subjected to heat treatment at an ambient temperature of 130° C. for 50 minutes.

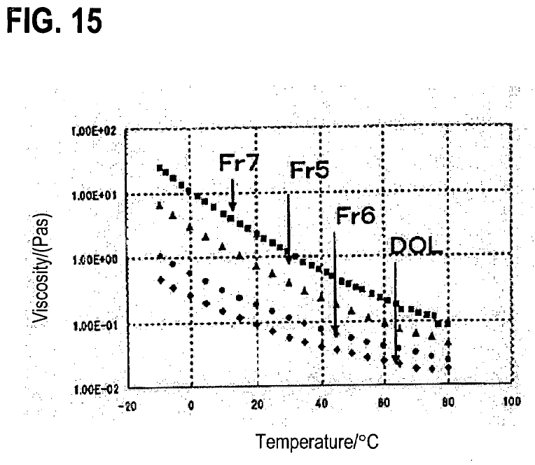

CSS tests were carried out repeatedly at an ambient temperature of 5° C. The result was that with Fr1 to Fr6 and Fr1T to Fr6T, faultless operations were possible for more than 50,000 times, which is the standard, while head crash occurred with Fr7 at the approximately 38,000'th round. In other words, when the molecular weight exceeded 12,000, the durability at a low temperature was significantly decreased. This was due to significant increase of the viscosity at a low temperature as shown in FIG. 15.

### Example 8

Among the lubricants synthesized in EXAMPLE 1, Fr4, Fr5 and Fr6 were subjected to the measurements of viscosity (unit: Pas) at 20° C. and diffusion coefficient (unit: μm²/s) at 23° C. The results are shown in TABLE 3. The relationship between the viscosity and the natural logarithm of diffusion coefficient at 23° C. satisfies the relationship of Y<−1.4475X+2.815 as shown in FIG. 20, when the natural logarithm of diffusion coefficient at 23° C. (unit; μm²/s) is potted as Y, and the viscosity at 20° C. (unit; Pas), as X. Here, the diffusion coefficient was determined by the half dip method, and the viscosity was determined with a rotational viscometer. In the half-dip method, it is important that the border between the region where a lubricant is coated and the region where a lubricant is not coated is clear just after the application of the lubricant, that is, a lubricant is coated so that the border line is formed on the disk surface as vertically as possible.

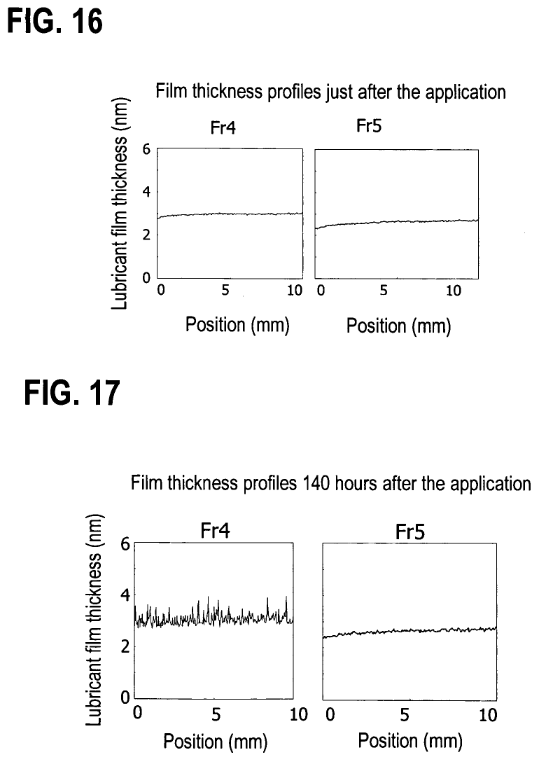

These lubricants were uniformly applied to magnetic disks in a thickness of about 3 nm, kept standing at room temperature for 140 hours, and then the states of cohesion (or coagulation) were observed. As a result, no conspicuous cohesion was observed. The film thickness profiles just immediately after the application and 140 hours after the application are shown in FIGS. 16 and 17.

TABLE 3

| | Viscosity at 20° C. | ln[diffusion coefficient |
|---|---|---|
| Lubricant | (Pas) | (unit: μm²/s)] |
| Fr4 | 0.323 | 1.9595 |
| Fr5 | 0.613 | 0.8856 |
| Fr6 | 1.39 | −1.2123 |

### Comparative Example 1

To compare, lubricants (A, B, C) comprising fluorine-containing polymers, the lubricants having the relationship of Y=−1.4475X+2.815 when the natural logarithm of diffusion coefficient at 23° C. was potted as Y, and the viscosity at 20° C., as X, were applied to magnetic disks in the same way as for EXAMPLE 8, and the states of cohesion (or coagulation) were observed after standing them for 140 hours. Here, the diffusion coefficient was determined by the half-dip method, and the viscosity was determined with a rotational viscometer.

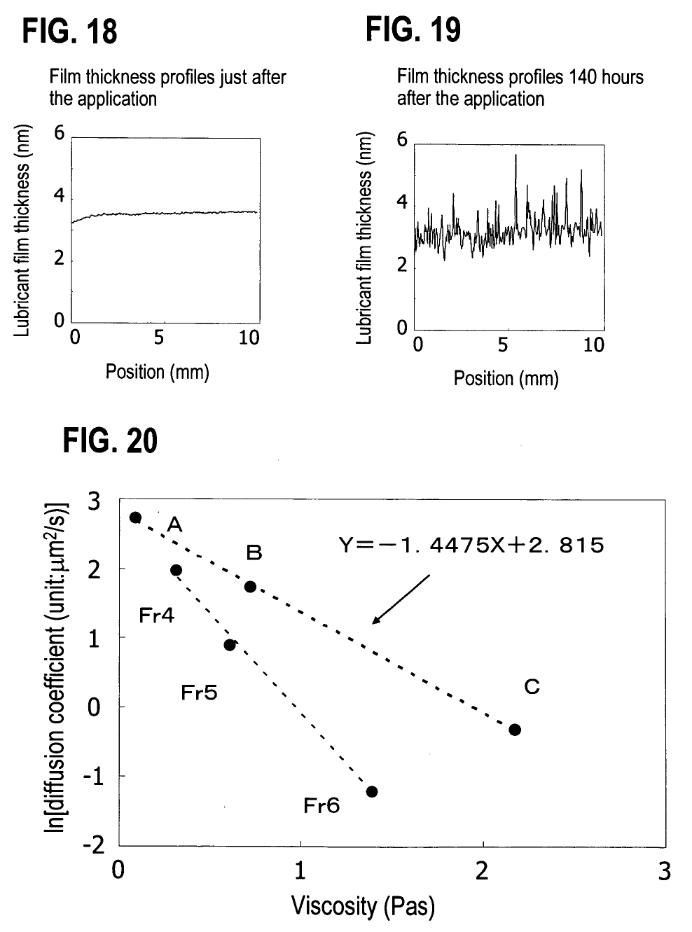

TABLE 4 shows the relationship between the viscosities and the diffusion coefficients at 23° C. of the used lubricants. FIGS. 18 and 19 show the respective film thickness profiles immediately after the application, and after 140-hour standing at room temperature. In addition, FIG. 20 shows the relationship between the viscosities and the diffusion coefficients at 23° C. as compared with the relationship of lubricants in EXAMPLE 8.

TABLE 4

| | Viscosity at 20° C. | ln[diffusion coefficient |
|---|---|---|
| Lubricant | (Pas) | (unit: μm²/s)] |
| A | 0.089 | 2.7079 |
| B | 0.727 | 1.732 |
| C | 2.18 | −0.3281 |

### Example 9

### (Synthesis of a Lubricant)

To the lubricant obtained in EXAMPLE 1, 2.2 equivalents of potassium tertiary-butoxide dissolved in tertiary butanol and tetrahydrofuran was added. Afterwards, 2 equivalents of glycidol was added. The mixture was reacted at room temperature for 6 hours. Trifluoroacetic acid in an amount of 25 g and 250 mL of water were added, followed by agitation at 70° C. for 3 hours. A deposit was recovered, and was washed with water at 80° C.

It was determined by FT-IR, ¹HNMR, ¹³CNMR, and ¹⁹FNMR that this polymer had a molecular structure represented by formula 1, wherein a=b=0, m=0.28, n=0.86, and δ=0.25.

What is claimed is:

1. A lubricant comprising a fluorine-containing polymer, said lubricant having a relationship: Y<−1.4475X+2.815, wherein Y is a natural logarithm of diffusion coefficient at 23° C. (unit:μm²/s); and X is a viscosity at 20° C. (unit: Pas).

2. A lubricant comprising a fluorine-containing polymer having a structure represented by formula 1, and with molecular chains between adjacent polar groups that have a number-average molecular weight of not less than 500:
H—{(XZ)ₘ, (YZ)ₙ}—(X_{δ}, Y_{(1-δ)}—H (1)
[{in formula 1, m and n are each a real number not less than zero (where m and n are not zero at the same time); {(XZ)ₘ, (YZ)ₙ} indicates that the structural unit XZ and the structural unit YZ may be mutually in a random sequence or blocked sequence; similarly, (X_{δ}, Y_{(1-δ)}) indicates that the structural unit X and the structural unit Y may be mutually in a random sequence or blocked sequence; δ is a real number not less than zero and not more than 1; the chemical structures of X, Y and Z are as shown in formulae 12, 13 and 14 in this order (where each hydrogen of X, Y and Z may be replaced with an organic group having 1-3 carbons that may comprise an ether bond, and also comprise either one or both of a polar group and fluorine as substituents for hydrogen thereof),
—O(CH₂CH₂O)ₐCH₂CF₂O(CF₂CF₂O)ₚ(CF₂O)_{q}CF₂CH₂(OCH₂CH₂)_{b}O (12)
{in formula 12, a, b, p and q are each a real number not less than zero (where p and q are not zero at the same time); and the structure units of CF₂CF₂O and CF₂O may be mutually in a random sequence or blocked sequence}, 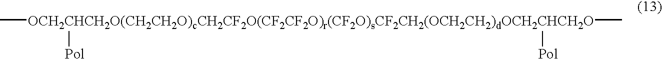
{in formula 13, c, d, r and s are each a real number not less than zero (where r and s are not zero at the same time); the structure units of CF₂CF₂O and CF₂O may be mutually in a random sequence or blocked sequence; and Pols are, independently from each other in the formula and from the other formulae, a polar group}, 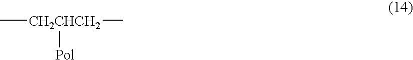
(in formula 14, Pol is, independently from the other formulae, a polar group)].

3. A lubricant according to claim 2, wherein the average molecular weight of said fluorine-containing polymer is not less than 2,000 and not more than 12,000.

4. A lubricant according to claim 2, wherein said Pol is a hydroxy group.

5. A lubricant according to claim 2, wherein the number-average molecular weight of molecular chains between adjacent polar groups of said fluorine-containing polymer is not more than 3,000.

6. A lubricant according to claim 2 wherein said fluorine-containing polymer has a terminal group with a structure represented by formula 3,
—R (3)
(in formula 3, R is a polar group or hydrocarbon group).

7. A lubricant according to claim 2 wherein part or the whole of the structure units of CF₂O and C₂F₄O of formula 1 is replaced with either one of structures represented by formulae 4 and 5.

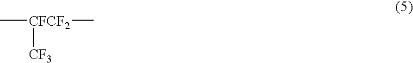

8. A lubricant according to claim 2 wherein said fluorine-containing polymer has no polar group except for a hydroxy group.

9. A lubricant according to claim 2 wherein said fluorine-containing polymer has from 1.0to 10.0 hydroxy groups on an average in a molecule at intermediate sections of the molecular chains.

10. A lubricant comprising a fluorine-containing polymer formed by reacting a compound having a structure represented by formula 2 and epichlorohydrin, having a number-average molecular weight of not less than 2,000 and not more than 12,000, and having from 1.0 to 10.0 hydroxy groups on an average in a molecule at intermediate sections of the molecular chains,
HO(CH₂CH₂O)ₓCH₂CF₂O(CF₂CF₂O)_{p″}(CF₂O)_{q″}CF₂CH₂(OCH₂CH₂)_{y}OH (2)
{in formula 2, p″, q″, x, and y are, independently from each other, a real number not less than zero (where p″ and q″ are not zero at the same time); and the structure units of CF₂CF₂O and CF₂O may be mutually in a random sequence or blocked sequence}.

11. A lubricant according to claim 10, said lubricant comprising a fluorine-containing polymer formed by reacting a compound having a structure represented by formula 2 and epichlorohydrin followed by reaction with glycidol, having a number-average molecular weight of not less than 2,000 and not more than 12,000, and having from 1.0 to 10.0 hydroxy groups on an average in a molecule at intermediate sections of the molecular chains.

12. A lubricant according to claim 10, wherein said fluorine-containing polymer has a terminal group with a structure represented by formula 3,
—R (3)
(in formula 3, R is a polar group or a hydrocarbon group).

13. A lubricant according to claim 10, wherein part or the whole of the structure units of CF₂O and C₂F₄O of formula 2 is replaced with either one of structures represented by formulae 4 and 5.
—CF₂CF₂CF₂— (4)

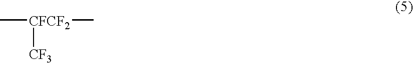

14. A lubricant according to claim 2, said lubricant comprising a fluorine-containing compound other than said fluorine-containing polymer.

15. A lubricant according to claim 14, wherein said fluorine-containing compound other than said fluorine-containing polymer is at least one compound selected from the group consisting of compounds having structures represented by formulae 9, 10 and 11, 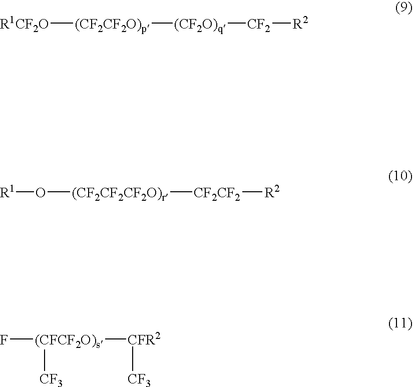
(in formulae 9-11, R¹ and R² are, independently from each other in a formula and in each formula independently from the other formulae, a group selected from the group consisting of a hydroxy group, a carboxy group, an amino group, and a phosphazene ring, a monovalent aliphatic hydrocarbon group that comprises, as a substituent group or substituent groups, one or more groups selected from the group consisting of a hydroxy group, a carboxy group, an amino group, and a phosphazene ring, may comprise a carbonyl group, an ether group, or carbonyl and ether groups, may comprises a double bond, a triple bond, or double and triple bonds, and may be branched, and a monovalent aromatic hydrocarbon group and a monovalent heterocyclic aromatic hydrocarbon group that have each, as a substituent group or substituent groups, one or more groups selected from the group consisting of a hydroxy group, a carboxy group, an amino group, and a phosphazene ring; p′, q′, r′ and s′ are each a positive real number; and each structure unit in formulae 9-11 may be mutually in a random sequence or blocked sequence in the structure of each compound).

16. A lubricant according to claim 2, wherein said lubricant comprising a fluorine-containing polymer has a relationship: Y<−1.4475X+2.815, wherein Y is a natural logarithm of diffusion coefficient at 23° C. (unit:μm²/s); and X is a viscosity at 20° C. (unit: Pas).

17. A magnetic recording medium comprising a magnetic layer, a protective layer over said magnetic layer, and a magnetic recording medium lubricant layer on the protective layer, wherein said magnetic recording medium lubricant layer is formed by application of a lubricant according to claim 1.

18. A magnetic recording medium comprising a magnetic layer, a protective layer over said magnetic layer, and a magnetic recording medium lubricant layer on the protective layer, wherein said magnetic recording medium lubricant layer is formed by application of a lubricant according to claim 2.

19. A head slider equipped with a record transducer for recording/record-reproducing to/from a magnetic recording medium, said head slider having, on the surface facing said magnetic recording medium, a protective layer and a head slider lubricant layer formed by application of a lubricant according to claim 1.

20. A head slider equipped with a record transducer for recording/record-reproducing to/from a magnetic recording medium, said head slider having, on the surface facing said magnetic recording medium, a protective layer and a head slider lubricant layer formed by application of a lubricant according to claim 2.
